(19) United States
(12) Patent Application Publication
(10) Pub. No.: US 2011/0137586 A1
(43) Pub. Date: Jun. 9, 2011

(54) WIND TURBINE MONITORING AND ADJUSTING

(76) Inventors: Yong Jiang, North York (CA); Mike Clifton, Flagstaff, AZ (US); Ron Boniella, Flagstaff, AZ (US)

(21) Appl. No.: 12/791,671

(22) Filed: Jun. 1, 2010

Related U.S. Application Data
(60) Provisional application No. 61/223,326, filed on Jul. 6, 2009.

(51) Int. Cl. G01C 9/04; G01H 1/00

(52) U.S. Cl. 702/56; 702/150

(57) ABSTRACT

Systems, devices, and methods are provided for leveling and monitoring a wind turbine tower. An exemplary system may comprise an accelerometer, signal transfer device, signal receiving device and signal display device. In an exemplary embodiment, the system is installed at or near the top of the wind turbine tower. The system maybe permanently installed. The installer may adjust tower mounting nuts to level the tower based on the display device information. In another exemplary embodiment, the system may be used for monitoring tower vibration during wind turbine operation and measuring wind speed during wind turbine operation.

### CROSS REFERENCE TO RELATED APPLICATIONS

This application is a non-provisional of U.S. Provisional Application No. 61/223,326, filed on Jul. 6, 2009, and entitled “WIND TURBINE TOWER LEVELING SYSTEM”, and is hereby incorporated by reference.

### FIELD

The subject of this disclosure may relate generally to systems, devices, and methods for leveling a wind turbine tower, and more particularly, relates to a system that can report information.

### BACKGROUND

Numerous devices have been used to aid in the installation of a wind turbine tower so that the tower is vertically leveled. Typically a bubble leveler is used at the top of the tower and a bucket truck is used to bring the installer to the tower top during installation. A typical bubble leveler, as illustrated in FIG. 1, is described in U.S. Pat. No. 168,401 issued Oct. 8, 1951 to Todd Harris, which teaches a bubble level device. Likewise, U.S. Pat. No. 4,858,723 issued Aug. 22, 1989 to William K. Holmes etc. teaches a bucket truck for lifting people to reach for example the tower top, as illustrated in FIG. 2.

However, such devices and systems are cumbersome and time consuming. For example, the installer may have to make multiple trips in the bucket to the top of the tower between adjustments. In other instances, using such tools for an installation would involve multiple people such that one person could read the bubble level while another person on the ground made adjustments. In short there is a need for improved methods of leveling a tower during and after installation.

In addition, in the prior art, wind turbines have been difficult to maintain/inspect. Typically, inspection involves a worker going up to the top of the tower (such as in a bucket shown in FIG. 2), or lowering the turbine to assess the mechanical condition. Both of these methods are cumbersome and undesirable. There is a need for improved methods of determining the health of the wind turbine.

Also, it is useful to know the wind speed at the elevation of the wind turbine. In the prior art, anemometers have been used to determine the wind speed. These anemometers are expensive and therefore are only suitable for large wind projects. Moreover, anemometers have proven to be somewhat unreliable. Thus, there is a need for improved methods of determining wind speed at the elevation of small wind turbines.

### SUMMARY

In accordance with an exemplary embodiment, systems, devices and methods are disclosed for facilitating setting and leveling a wind turbine tower. In one exemplary embodiment, the system comprises a wind turbine, a tower with the wind turbine on top of the tower, and an accelerometer. In this exemplary embodiment, the system may be installed at or near the top of the wind turbine tower. In addition, the system may be permanently or removably installed for additional convenience.

Accordingly, in an exemplary embodiment, systems, devices and methods are disclosed that are configured to provide an installer with tower level information at ground level through the display device and to facilitate the installer in adjusting the tower to level position accordingly. In an exemplary embodiment, the system further comprise a tower leveling device configured to use data from the accelerometer to facilitate leveling the wind turbine atop the tower. The installer may adjust tower mounting nuts to level the tower based on the display device information. In another exemplary embodiment, systems, devices and methods are disclosed that verify the tower level information over time, and facilitate re-adjusting the tower to level accordingly.

In addition to leveling, accelerometer data and information may also be used to indicate vibration differences and determine wind speed. In an exemplary embodiment, the system further comprises a vibration monitoring device configured to use data from the accelerometer to facilitate monitoring vibrations at the wind turbine atop the tower. In another exemplary embodiment, the system can report tower vibration data via a direct cable connection or a wireless connection. Vibration data may indicate that the wind turbine tower requires maintenance or preventive adjustments.

In a third exemplary embodiment, the system can report tower top wind speed. In an exemplary embodiment, the system further comprises a wind speed monitoring system configured to use data from the accelerometer and a strain gauge to facilitate monitoring wind speed at the wind turbine atop the tower. In an exemplary embodiment, systems, devices and methods are disclosed that report tower top wind speed through for example, computers. In another exemplary embodiment, systems, devices and methods are disclosed that record tower leveling and vibration information through for example, computers.

### BRIEF DESCRIPTION OF THE DRAWINGS

These and other features, aspects and advantages of the present invention will become better understood with reference to the following description, appending claims, and accompanying drawings where:

FIG. 1 illustrates a bubble level commonly used in wind turbine tower installation, in accordance with prior art methods;

FIG. 2 illustrates a bucket truck commonly used in wind turbine tower installation, in accordance with prior art methods;

FIG. 3 illustrates an exemplary system diagram in accordance with an exemplary embodiment of the present invention;

FIG. 4 illustrates a block diagram of an exemplary up-tower unit; and

FIGS. 5-12 illustrate various exemplary components for the physical housing of an exemplary up-tower system.

### DETAILED DESCRIPTION

In accordance with an exemplary embodiment of the present invention, systems, devices, and methods are provided, for among other things, tower leveling. The following descriptions are not intended as a limitation on the use or applicability of the invention, but instead, are provided merely to enable a full and complete description of exemplary embodiments.

The present invention may employ various integrated circuit components (e.g., memory elements, processing elements, logic elements, look-up tables, and the like), which may carry out a variety of functions under the control of one or more mircroprocessors or other control devices. Similarly, the software elements of the present invention may be implemented with any programming or scripting language such as C, C++, Java, COBOL, assembler, PERL, extensible markup language (XML), JavaCard and MULTOS with the various algorithms being implemented with any combination of data structures, objects, processes, routines or other programming elements. Further, it should be noted that the present invention may employ any number of conventional techniques for data transmission, signaling, data processing, network control, and the like.

By communicating, a signal may travel to/from one component to another. The components may be directly connected to each other or may be connected through one or more other devices or components. The various coupling components for the devices can include but are not limited to the Internet, a wireless network, a conventional wire cable, an optical cable or connection through air, water, or any other medium that conducts signals, and any other coupling device or medium.

In accordance with various exemplary embodiments of the present invention, a wind turbine tower system comprises a wind turbine and an accelerometer, where the accelerometer comprises one or more accelerometers sensors configured for sensing acceleration, position, vibration and/or the like. In one exemplary embodiment, the accelerometer is located at the top of the tower. In another exemplary embodiment, the accelerometer is located near the top of the tower. In an exemplary embodiment, the accelerometer is a multi-axis accelerometer. However, the accelerometer may be any type of accelerometer configured to sense acceleration, position, vibration and/or the like now known or hereafter developed.

In an exemplary embodiment, the accelerometer is configured to sense three direction position (static motion) data and output three directions acceleration data: X-axis, Y-axis and Z-axis. This acceleration data is low-pass filtered to produce the static position data. In accordance with an exemplary embodiment, this accelerometer data may be used to facilitate tower leveling, among other uses. Furthermore, static and/or dynamic data from the accelerometer can be used to diagnose maintenance issues, monitor wind speed, and the like.

In accordance with various exemplary embodiments, data sensed by the accelerometer is communicated from the top of the tower to the bottom of the tower. In one exemplary embodiment, the system comprises an accelerometer, signal transfer device, signal receiving device and signal display device. For example, the accelerometer may be configured to communicate sensed data with a signal transfer device in the tower top, and the signal transfer device may communicate such sensed data to a signal receive device in the tower bottom. The communication between the signal transfer device and signal receive device may, for example, occur over a cable, a power line communication method, or a wireless method (e.g., zigbee). The signal receive device may be configured to communicate the sensed data to a signal display device near ground level, and/or in/near the tower bottom.

In other exemplary embodiments, data from the accelerometer may be communicated to remote locations. For example, data may be transmitted to a remote control center via a radio tower or a satellite. This remotely transmitted information could be used to schedule maintenance or even remotely shutdown the wind turbine tower system. In yet further exemplary embodiments, data from the accelerometer may be used locally for automatic control of the wind turbine. For example, a processor located in the turbine tower (such as in the nacelle) may be programmed to shutdown the turbine under certain conditions.

In accordance with an exemplary embodiment, the three directions data may be displayed on a down-tower device, like a laptop, in the form of a graphical representation. One such representation is a small ball on the laptop screen in relation to a circular target, with tower levelness correlating to the small ball in the center of the target. It should be appreciated that various computers, hardware, and software may be used in accordance with the exemplary embodiments of the present invention. Also the three directions value may be displayed as text (e.g., a number) on the laptop screen. By adjusting the tower bottom nuts, the new tower top position leveling information will be displayed on the screen. The installer then can adjust the nuts to make the small ball be displayed in the center of the screen, at which point the tower is perfectly leveled. In addition to a graphical representation, other visual or audio indicators may be implemented. For example, lights or sounds may used. In one embodiment, a pulsing sound frequency or blinking light frequency provides feedback to a user that is indicative of the levelness of the wind turbine.

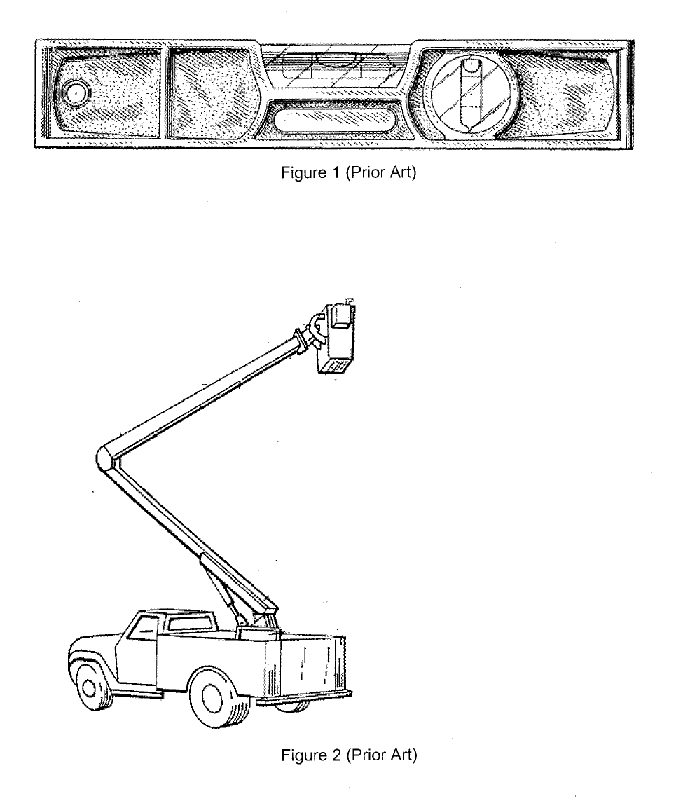

In an exemplary embodiment, a tower leveling device uses the accelerometer data to provide instructions indicative of adjustments that will cause the wind turbine to become more level. The instructions might indicate, for example, to tighten a particular nut, to loosen a particular nut, or to make any suitable adjustment that changes the orientation of the turbine relative to level. Furthermore, in an exemplary embodiment, the instructions may indicate to adjust at least one nut if the tower is far out of level, and to adjust at least one guy wire if the tower is close to level. In another exemplary embodiment, the system is configured to verify the tower level information over time, for example two years or so after tower installation. In this example, a user can readily re-adjust the tower to level several years after the original installation. The user can do this without calling out a technician, or at a minimum, without use of a bucket lift as shown in FIG. 2. This facilitates easy correction in the event that soil subsidence, structural deformation, or other changes over time cause the wind turbine to go out of level.

In an exemplary embodiment, the acceleration data is dynamic in nature and can be sampled at any rate. This data is sampled by a low-pass filter for various purposes. For example, in the tower leveling concept, the low pass filter cutoff frequency may be set as low as approximately 0.1 Hz so as to capture the static or DC value. It should be noted that the accelerometer and/or the device supporting the accelerometer may be calibrated before installation. For example, the turbine and accelerometer may be placed on level surface and the accelerometer calibrated. This may be done prior to shipping the wind turbine to a customer.

In various exemplary embodiments, the tower is a mono-pole type tower. In this exemplary embodiment, the leveling may be accomplished by adjusting fasteners, such as nuts, near the ground level. In other exemplary embodiments, the tower may be supported by guy wires. In those exemplary embodiments, among other things, the leveling may be adjusted by changing the length/tension of the guy wires. In yet another exemplary embodiment, the tower is a lattice type tower structure. In other exemplary embodiments, the tower may be direct embedded. In this exemplary embodiment, the tower top may further include a stub for facilitating leveling. Thus, the disclosure herein may be applicable for any suitable tower.

In addition to system tower leveling, in another exemplary embodiment, a system is provided for monitoring tower vibration and system performance/calibration. In an exemplary embodiment, the accelerometer is configured to sense tower top vibration data. In this exemplary embodiment, a vibration monitoring device uses the vibration data to facilitate determining the health and or maintenance needs of the wind turbine. In various exemplary embodiments, by recording the accelerometer output data, the tower top vibration is directly analyzed and recorded. For example, in one exemplary embodiment, the tower top vibration data is used to determine if the wind turbine is out of balance. In another example, the tower top vibration data is used to determine if the wind turbine has a bad bearing. In other exemplary embodiments, the vibration data may be indicative of maintenance and/or preventative maintenance that should be performed. The system may provide warning signals or messages that maintenance should be performed. In yet another exemplary embodiment, the vibration data may trigger an automatic shut down of the wind turbine to protect the machinery. As an example, if ice build up on one blade were greater than on another blade, vibration data may indicate that the wind turbine was out of balance and take appropriate action. In this exemplary embodiment, the vibration detection may involve additional signal processing. For example, the signal may be processed through a low pass filter and a peak detection algorithm. The signal processing may determine whether turbine imbalance exists, or any other condition of note. The signal processing may further provide output indicative of the conditions being monitored. The output may further facilitate alarming on certain pre-defined conditions.

In yet another exemplary embodiment, a wind speed monitoring system is configured to use the accelerometer data in combination with other turbine data, such as turbine RPM, to calculate wind speed data, where the wind speed is “measured” at or near the top of the tower. In yet another exemplary embodiment, the wind speed monitoring system may use this data to estimate the wind speed at the turbine. In this exemplary embodiment, data from the accelerometer may be combined with other data and used to estimate wind speed. For example, data from the accelerometer may be combined with turbine revolutions per minute (“RPM”) data and/or strain gauge data and fed through an algorithm to estimate wind speed. The wind speed estimate is an estimate of wind speed at the turbine height. The strain gauge data may be strain gauge data from near the bottom of the tower, where the strain gauge is attached to the tower. The strain gauge may output data showing how much strain is being applied to the tower because of the impact of the wind on the turbine, etc.

The estimate may be based on formulas, empirical data, look up tables, and/or the like. In this exemplary embodiment further processing may be used. For example, an observer algorithm may be used, which uses a model of the torsional dynamics of the wind turbine coupled to the fore-aft dynamics of the turbine tower and, for example, using a Kalman filtering scheme to estimate the wind speed. Other methods of signal processing that estimate the wind speed based on information from, among other components, an accelerometer may also be used.

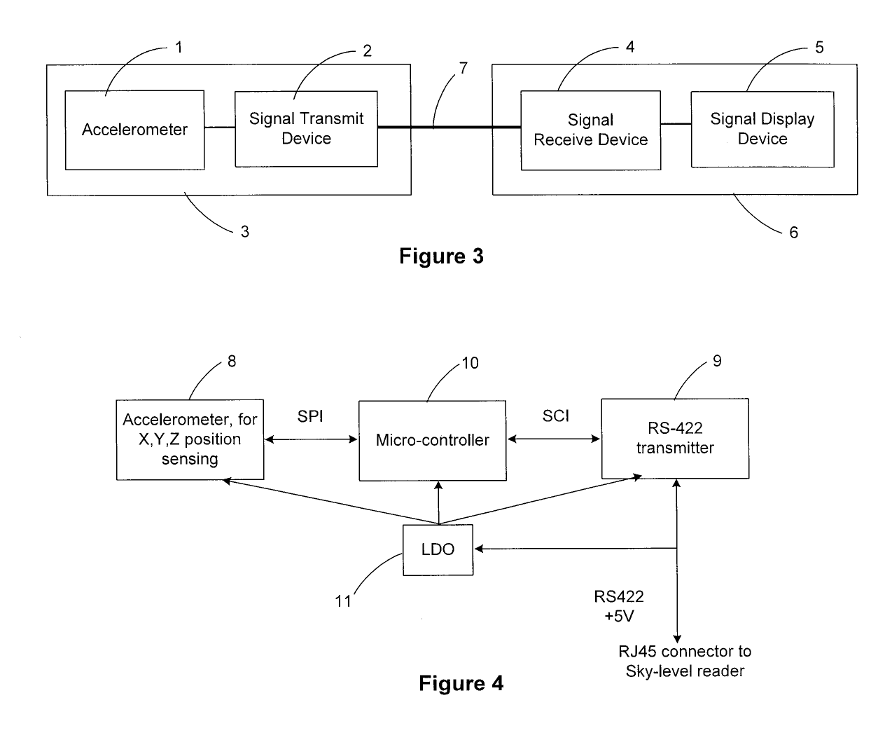

Having described various exemplary embodiments, further embodiments and functions and features can be illustrated with reference to the figures. The various exemplary embodiments may comprise various structures to accomplish one or more functions. For example, in accordance with an exemplary embodiment, and with reference to FIG. 3, a tower accelerometer system may comprise an up-tower unit 3 and a down-tower unit 6. The tower accelerometer system may further comprise, in an exemplary embodiment, an accelerometer 1. Accelerometer 1 may comprise a semiconductor based sensor configured to provide x-axis, y-axis and z-axis (three direction position data). For example, accelerometer 1 may be model LIS3LV02DL. The tower accelerometer system may also comprise, in a further exemplary embodiment, a signal transfer device 2 and a signal receive device 4. In one embodiment, signal transfer device 2 and signal receive device 4 are both transceivers, such as model ISL83071. In an exemplary embodiment, signal transfer device 2 may be located in up-tower unit 3 and signal receive device 4 may be located in down-tower unit 6. Signal transfer device 2 may be configured to transfer position values through a cable 7 to signal receive device 4. In turn, signal receive device 4 may be configured to communicate the position values to a signal display device 5.

Signal display device 5 is configured to display the position values and/or information derived there-from that may facilitate making adjustments to level the tower. In one embodiment, signal display device 5 is a Liquid Crystal Display (LCD) screen laptop. The tower accelerometer system may further comprise devices and or algorithms for changing the format of the position values as suitable for communication, computation, and/or display. In an exemplary embodiment, signal display device 5 comprises a visual source that may be a light, multiple lights, gauge, display or the like. For example, in an exemplary embodiment the visual source is a light that changes pulsing rate and/or intensity based on received signal strength. The visual source can be used to indicate leveling and aid in the alignment of the tower. A display or gauge could include a leveling proximity strength number or histogram-type indicator.

In an exemplary embodiment and with reference to FIG. 4, an up-tower unit 3 comprises an accelerometer 8, a transceiver 9, and a controller 10. The up-tower unit may further comprise a voltage regulator 11, such as a low-dropout regulator. In an exemplary embodiment, a cable connects to transceiver 9 to facilitate data transfer and connects to voltage regulator 11 to supply power. In an exemplary embodiment, controller 10 is a microcontroller configured to communicate with accelerometer 8 using a serial peripheral interface. In another exemplary embodiment, microcontroller 10 communicates with transceiver 9 using a serial communications interface.

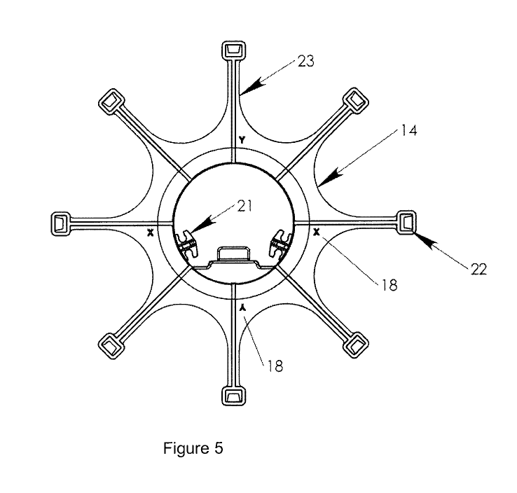

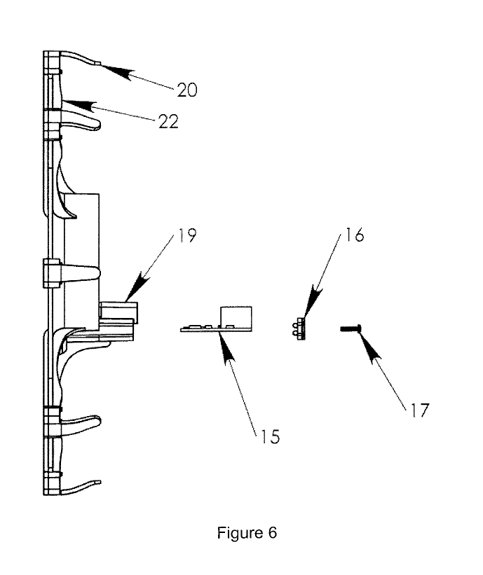

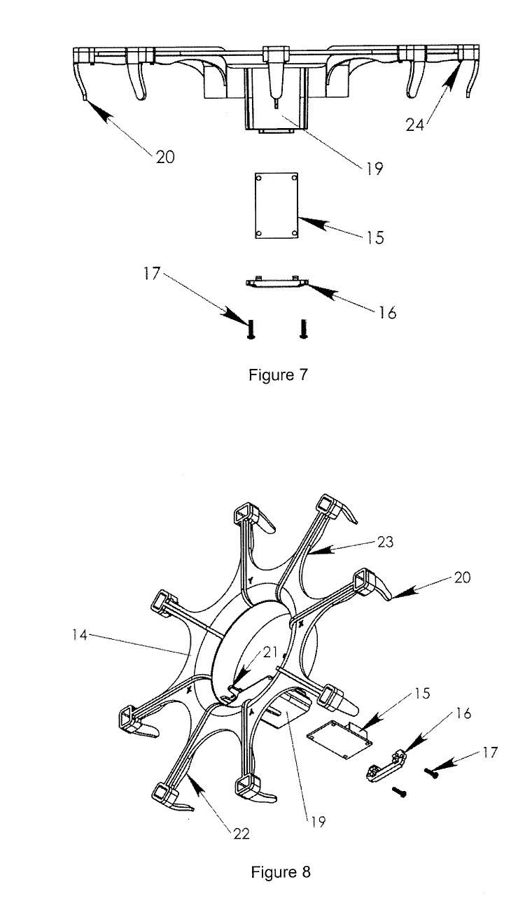

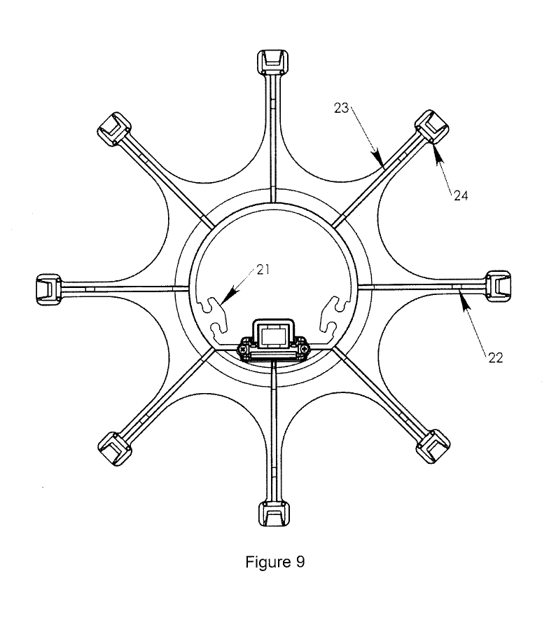

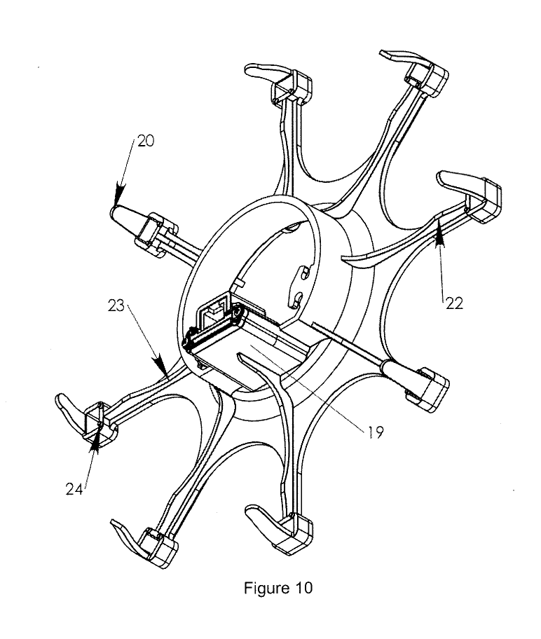

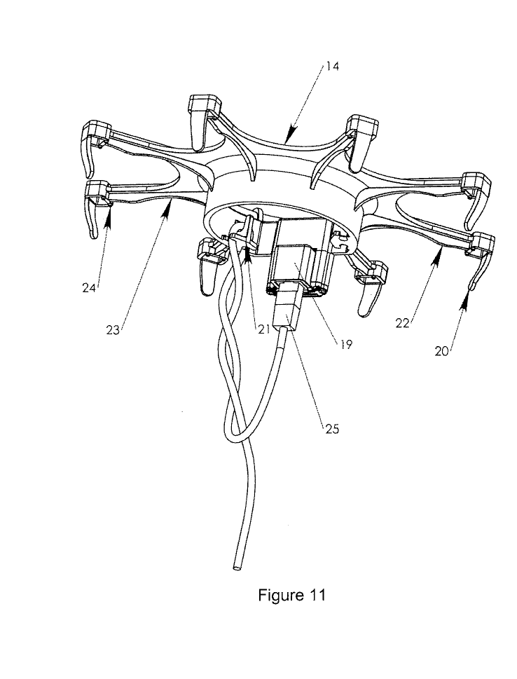

With reference now to FIGS. 5-12, in accordance with various components used in one of more exemplary embodiments, an accelerometer housing and support structure 14 is illustrated. Accelerometer housing and support structure 14 is, for example, configured for use with monopole towers, guyed towers, lattice towers and the like. In one exemplary embodiment, the support structure is made from an industrial grade injection molded thermoplastic. In other embodiments, the support structure is made from any suitable plastic, suitable metallic material, or a combination thereof. The support structure design can easily be adapted for any tower top and base geometry and for internal or external mounting at any location along the length of the tower mast. The effectiveness of the accelerometer is dependent on the sensitivity of the accelerometer and the position of the accelerometer in the tower mast. An exemplary accelerometer PCB 15 may be configured to nest securely into support structure housing 14 and, for example, is constrained by slots located in the bottom of the housing pocket. The accelerometer may be embedded into support structure housing 14 or may be removably attached to support structure housing 14. In addition, in an exemplary embodiment, the accelerometer is located on the top of the tower or the side wall of the tower.

A housing cover 16, in an exemplary embodiment, is configured to securely constrain the six degrees of freedom of accelerometer PCB 15, preventing movement of the calibrated device in normal operating conditions for the life of the design. Furthermore, cover fasteners 17, in an exemplary embodiment, are self tapping and vibration resistant fasteners. Support structure housing 14 may further comprise molded markings 18 on the support structure to provide easy reference for assembly and proper orientation. In one exemplary embodiment, accelerometer housing and support structure 14 may further comprise a housing 19 configured to receive accelerometer PCB 15 and further comprising internal features within the housing pocket to lock accelerometer PCB 15 into location. In an exemplary embodiment, a snap fit clip 20 may be configured to accurately locate support structure housing 14 to a tower top flange and eliminate the need for mounting hardware. In an exemplary embodiment, snap fit clips 20 may be configured to exert even pressure on the tower providing uniform contact of the pads to the tower and prevent movement during normal operation.

In other exemplary embodiments, support structure housing 14 may use other devices for securing itself to the tower. For example, permanent magnets may also be used to securely mount and locate support structure housing 14 to a ferrous tower. The snap fit clip design can easily be adapted to accommodate an infinite number of tower top and pole mast geometries. Support structure housing 14 may further comprise one or more strain relief hooks 21. In an exemplary embodiment, strain relief hook 21 may be configured to support the weight of the signal cable and prevent the connector from pulling out under tension. Strain relief hook 21 is useful, for example, with a direct connect cable system.

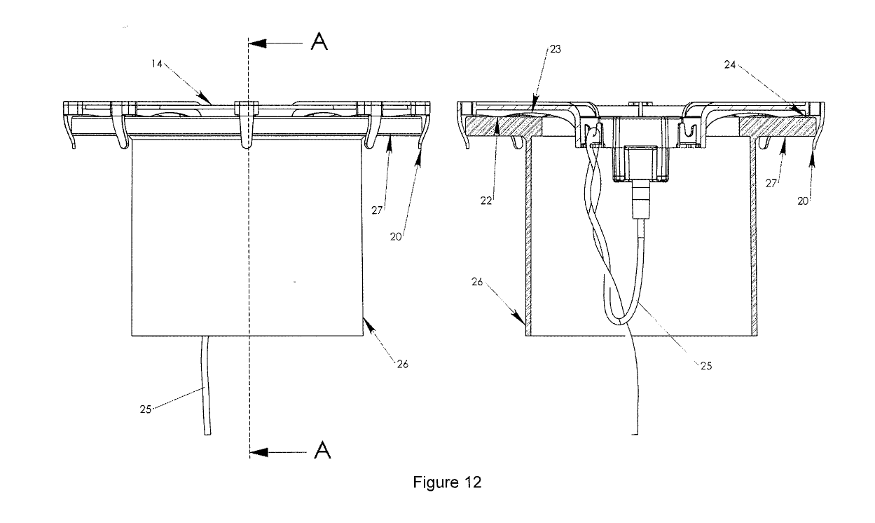

In another exemplary embodiment, support structure housing 14 may further comprise a contact pad 22. Contact pad 22, in an exemplary embodiment, is configured to facilitate proper interface with a tower top surface. In yet another exemplary embodiment, support structure housing 14 may further comprise a support arm articulation region 23. Support arm articulation region 23, in an exemplary embodiment, is configured and designed to deflect and conform to irregular (non-planer) surfaces. This may facilitate improving pad contact with the tower, while maintaining proper accelerometer positioning. Support structure housing 14 may further comprise contact pad stops 24. Contact pad stops 24 may, in an exemplary embodiment, prevent the support arms from being over compressed. Over compression of the support arms can lead to distortion and misalignment of the accelerometer. The system may further comprise a signal cable and connector 25. Signal cable and connector 25 may be, in an exemplary embodiment, configured for programming the electronics and for connecting directly to accelerometer. With reference to FIG. 12, an illustration of a tower top pole 26 is provided. Tower top pole 26 may comprise a tower top flange 27.

In accordance with an exemplary embodiment, a tower system comprises an up-tower unit (the assembly mounted on top flange of tower (pole)) and down-tower unit (the interface device converting a sky-level signal to USB signal which can be directly connected with a PC/laptop). As previously described, the up-tower unit may include accelerometer housing and support structure 14 enclosing a circuit board. A long CAT5 cable is configured to connect a first end to a signal transceiver at the up-tower unit, and the second end to a signal transceiver in the down-tower unit at the bottom of the tower.

The cable bottom end may be protected by a rubber cap from water and dust. In one exemplary embodiment, these above parts are permanently installed during the tower installation. In other exemplary embodiments, some or all of the above parts are removable. The down-tower unit may include a small plastic box enclosing a circuit board configured to convert the up-tower unit signal to a USB signal and provide power from the USB port to the up-tower unit. A standard five feet USB A-B male cable may be used to connect the sky-level reader to a PC/laptop. Furthermore, the accelerometer data to vibration conversion, accelerometer data to leveling conversion, and accelerometer data to wind speed conversion may involve any suitable algorithms.

It is noted that in various exemplary embodiments, the accelerometer leveling system facilitates re-leveling the tower after a period of time/use has passed. For example, wind, ground subsidence, deformation, and/or the like may cause a once level tower to become out of level. In accordance with various exemplary embodiments, the tower may be re-leveled from the ground a period of time after installation of the tower. For example, the tower may be re-leveled a month or year or more removed from the original installation, and with minimal inconvenience.

In accordance with an exemplary embodiment, a wind turbine system comprises a wind turbine, a tower with the wind turbine on top of the tower, an accelerometer; and a vibration monitoring device configured to use data from the accelerometer to facilitate monitoring vibrations at the wind turbine atop the tower. Furthermore, in an exemplary embodiment, the accelerometer comprises one or more accelerometer sensors and is further configured to output a data signal which includes information representative of vibration data for the tower top. In one embodiment, the wind turbine system further comprises a signal transfer device, wherein the signal transfer device is configured to communicate the data signal from the accelerometer to a tower bottom. Also, the data signal may be communicated via one of: a cable, a power line communication method, and a wireless method. In yet another exemplary embodiment, the wind turbine system further comprises a tower health indicator, wherein the tower health indicator is configured to indicate whether maintenance is recommended for the wind turbine. The tower health indicator may be configured to indicate at least one of: if the wind turbine is out of balance, and if the wind turbine has a bad bearing. In an exemplary embodiment, the wind turbine system further comprises a strain gauge connected to the tower, and a wind speed monitoring system configured to use data from the accelerometer and the strain gauge to facilitate monitoring wind speed at the wind turbine atop the tower. In another exemplary embodiment, the wind turbine system further comprises a tower leveling device configured to use data from the accelerometer to facilitate leveling the wind turbine atop the tower.

In accordance with an exemplary embodiment, a wind turbine system comprises a wind turbine, a tower with the wind turbine on top of the tower, an accelerometer, a strain gauge connected to the tower, and a wind speed monitoring system configured to use data from the accelerometer and the strain gauge to facilitate monitoring wind speed at the wind turbine atop the tower. The accelerometer comprises one or more accelerometer sensors and is further configured to output a data signal which includes information representative of dynamic acceleration for the tower top. In one embodiment, the wind turbine system further comprises a signal transfer device, wherein the signal transfer device is configured to communicate the data signal from the accelerometer to a tower bottom. Moreover, the data signal may be communicated via one of: a cable, a power line communication method, and a wireless method. In another exemplary embodiment, the wind turbine system further comprises a wind speed indicator located at a location other than the tower top, wherein the wind speed indicator is configured to calculate the wind speed, at the wind turbine atop the tower, based on data from the accelerometer and data from the strain gauge. In yet another exemplary embodiment, the wind turbine system further comprises a vibration monitoring device configured to use data from the accelerometer to facilitate monitoring vibrations at the wind turbine atop the tower, and a tower health indicator located at a location other than the tower top, wherein the tower health indicator is configured to indicate whether maintenance is recommended for the wind turbine. Moreover, in an exemplary embodiment, the wind turbine system further comprises a tower leveling device configured to use data from the accelerometer to facilitate leveling the wind turbine atop the tower.

In an exemplary method, a method for determining information relevant to wind turbines comprises the steps of: receiving accelerometer data from an accelerometer that is located in proximity to a wind turbine located on top of a tower, receiving strain gauge data from a strain gauge that is located on the tower, and calculating, based on the accelerometer data and the strain gauge data: turbine leveling information, turbine health, and the wind speed at the turbine. In another exemplary method, the method further comprises the step of displaying one or more of the turbine leveling information, turbine health, and wind speed at the turbine.

In the description and/or claims, the terms “coupled” and/or “connected”, along with their derivatives, may be used. In particular embodiments, “connected” may be used to indicate that two or more elements are in direct physical and/or electrical contact with each other. “Coupled” may mean that two or more elements are in direct physical and/or electrical contact. However, coupled may also mean that two or more elements may not be in direct contact with each other, but yet may still cooperate and/or interact with each other. Furthermore, couple may mean that two objects are in communication with each other, and/or communicate with each other, such as two pieces of hardware. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

It should be appreciated that the particular implementations shown and described herein are illustrative of various embodiments including its best mode, and are not intended to limit the scope of the present disclosure in any way. For the sake of brevity, conventional techniques for signal processing, data transmission, signaling, and network control, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical communication system.

While the principles of the disclosure have been shown in embodiments, many modifications of structure, arrangements, proportions, the elements, materials and components, used in practice, which are particularly adapted for a specific environment and operating requirements without departing from the principles and scope of this disclosure. These and other changes or modifications are intended to be included within the scope of the present disclosure and may be expressed in the following claims.

We claim:

1. A wind turbine system comprising:
a wind turbine;
a tower with the wind turbine on top of the tower;
an accelerometer; and
a tower leveling device configured to use data from the accelerometer to facilitate leveling the wind turbine atop the tower.

2. The wind turbine system of claim 1, wherein the accelerometer comprises one or more accelerometers and is further configured to output a data signal which includes information representative of a tower top three direction position value.

3. The wind turbine system of claim 2, further comprising a signal transfer device, wherein the signal transfer device is configured to communicate the data signal from the accelerometer to a tower bottom.

4. The wind turbine system of claim 3, wherein the data signal is communicated via one of: a cable, a power line communication method, and a wireless method.

5. The wind turbine system of claim 4, wherein the system further comprises:
a strain gauge connected to the tower; and
a wind speed monitoring system configured to use data from the accelerometer and the strain gauge to facilitate monitoring wind speed at the wind turbine atop the tower.

6. The wind turbine system of claim 4, further comprising a vibration monitoring device configured to use data from the accelerometer to facilitate monitoring vibrations at the wind turbine atop the tower.

7. The wind turbine system of claim 6, further comprising a tower health indicator, wherein the tower health indicator is configured to indicate whether maintenance is recommended for the wind turbine.

8. A wind turbine system comprising:
a wind turbine;
a tower with the wind turbine on top of the tower;
an accelerometer, wherein the accelerometer comprises one or more accelerometer sensors and is configured to output an accelerometer data signal;
a strain gauge connected to the tower, wherein the strain gauge is configured to output a strain gauge data signal;
a processor configured to receive the accelerometer data signal and the strain gauge data signal and to calculate, based on the accelerometer data signal and the strain gauge data signal: turbine leveling information, turbine health, and the wind speed at the turbine; and
a user interface located remote from the top of the tower, wherein the user interface is configured to report: turbine leveling information, turbine health, and the wind speed at the turbine.

9. The wind turbine system of claim 8, further comprising a signal transfer device, wherein the signal transfer device is configured to communicate the accelerometer data signal to the processor, wherein the accelerometer data signal is communicated via one of: a cable, a power line communication method, and a wireless method.

10. The wind turbine system of claim 8, wherein the tower is a tilt-up tower.

11. The wind turbine system of claim 8, wherein the processor shuts down the wind turbine in response to the turbine health indicating maintenance of the wind turbine system should be performed.

12. The wind turbine system of claim 11, wherein the turbine health may indicate a bearing failure or the wind turbine is out of balance.

13. The wind turbine system of claim 8, wherein the user interface generates a graphical representation of the tower levelness based on the accelerometer data signal.

14. The wind turbine system of claim 8, wherein the wind turbine speed at the turbine is based on a combination of turning speed of the wind turbine, the accelerometer data signal, and the strain gauge data signal.

15. A method of leveling a tower supporting a wind turbine, wherein the wind turbine and the tower are associated with an accelerometer, the method comprising the steps of:
viewing an indicator on a device that provides information to a ground level user, wherein the indicator indicates what adjustments should be made to level the wind turbine, wherein the information is based on data from the accelerometer; and
adjusting the tower based on the information provided by the device.

16. The method of leveling the tower of claim 15, further comprising:
adjusting at least one of a plurality of nuts coupled to the tower bottom, wherein the device provides an indication as to which of the plurality of nuts to adjust by loosening or tightening;
adjusting at least one of a plurality of guy wires coupled to the tower top, wherein the device provides an indication as to which of the plurality of guy wires to adjust by loosening or tightening.

17. The method of leveling the tower of claim 16, wherein the device provides indications to adjust the plurality of nuts in response to the wind turbine being far out of level and to adjust the plurality of guy wires in response to the wind turbine being close to level.

18. The method of leveling the tower of claim 15, wherein the tower is a tilt up tower.
